(19) United States
(12) Patent Application Publication
(10) Pub. No.: US 2011/0109446 A1
(43) Pub. Date: May 12, 2011

(54) ALARM ENABLED EARPLUG AND RELATED METHOD OF USE

(76) Inventor: Nuwonia B. Alves, Sarasota, FL (US)

(21) Appl. No.: 12/750,298

(22) Filed: Mar. 30, 2010

Related U.S. Application Data
(60) Provisional application No. 61/259,300, filed on Nov. 9, 2009.

(51) Int. Cl. G08B 3/10; H04R 1/10

(52) U.S. Cl. 340/384.5; 381/74

(57) ABSTRACT

The invention is directed to an enhanced earplug having a first and second portion. The first portion includes both an external casing and an internal cavity of sufficient size and dimension to maintain a digital sound system. Preferably, the first portion is essentially rounded in shape having a first flat and a corresponding second flat end. The second portion includes a deformable member having a first flat end, a cylinder and a semi-circular second end. The second flat end of the first portion can be connected to the first flat end of the deformable member through a pivot member. The digital sound system can include programmable memory, a processor, an internal power source, and a display that provides a read out. The digital sound system can be programmed through two programming buttons. Optionally, the digital sound system can include a temperature sensor and a GPS chip to gauge distance traveled.

### CROSS-REFERENCE TO RELATED APPLICATIONS

The application seeks priority to U.S. Provisional Application No. 61/259,300 entitled “The Ear-Snoozer Ear Alarm Clock with Interchangeable Earplugs” filed on Nov. 9, 2009, the disclosure of which is hereby incorporated by reference in its entirety all commonly owned.

### FIELD OF THE INVENTION

This invention is directed to a deformable earplug, which includes a programmable digital alarm capable of alerting a user as to the time, date and other related alert information.

### BACKGROUND OF THE INVENTION

Earplugs represent popular and multi-functional devices, which provide a variety of applications and uses. In general, an earplug is a device inserted into the ear canal to protect the wearer's hearing from loud noises, the intrusion of water, foreign bodies, dust or excessive wind. The most common design characteristic of an earplug is some type of form fitting stem, which adheres and conforms to the wearer's ear canal. There are three primary types of earplugs: foam earplugs made of some form of memory foam, silicone earplugs which are rolled and molded to fit within the ear, and flanged earplugs often used by musicians.

Earplugs are often commercially used where work conditions present a large degree of artificial noise. Examples include, but are not necessarily limited to, use in construction sites, at airports and on large maritime vessels. In addition, earplugs are often used in non-commercial application. Examples here include sleeping or reading in large public areas such as on airplanes. Wearers often use earplugs when sleeping due to a spouse's snoring.

Regardless of the application, one drawback with current earplugs that due to their ability to block external noise, traditional earplugs prevent a wearer from observing various warnings present externally. For example, someone wearing earplugs while sleeping may not be alerted to an alarm clock going off. In another example, a person reading a book at an airport may not be notified that the flight is now boarding. Still as a third example, a construction worker wearing earplugs may not be aware that it is time for a requisite lunch break.

Accordingly, there is a need in the art of earplug design for an alarm enabled and programmable earplug that will allow a wearer to be informed as to the time of the day, date, and other related alert information. Such device should be lightweight, comfortable and easy to use.

### SUMMARY OF THE INVENTION

The invention is directed to an enhanced earplug having a first and second portion. The first portion is ergonomic and includes both an external casing and an internal cavity of sufficient size and dimension to maintain a digital sound system. Preferably, the first portion is essentially rounded in shape having a first flat and a corresponding second flat end. The second portion includes a deformable member having a first flat end, a cylinder and a semi-circular second end. The second flat end of the first portion can be connected to the first flat end of the deformable member through a pivot member.

The digital sound system can include programmable memory, a processor, an internal power source, and a display that provides a read out. The digital sound system can be programmed through two programming buttons. Optionally, the digital sound system can include a temperature sensor and a GPS chip to gauge distance traveled.

The invention is further directed to a method of providing an alarm to a user wearing earplugs. The method first includes the step of turning on a digital sound system positioned within a first portion of an enhanced earplug. Next, a user chooses a particular program stored on a memory device connected to the digital sound system. The program is stored on a memory device and performed by a processor also connected to the digital sound system. The third step is fitting a deformable member—located on a second portion of the enhanced earplug—within an ear canal of a user. The deformable member includes a first flat end, a cylinder and a semi-circular second end. The final step is sending an audible signal from the digital sound system the user through the semi-circular second end of the deformable member.

The digital sound system can be programmed to offer a variety of programs including an alarm clock, a count down feature, and a timer.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the two-part constructed alarm enabled earplug, which includes a display.

FIG. 2 is a top view of the alarm enabled earplug showing the first portion and corresponding second portion.

FIG. 3 is a side view of the alarm enabled earplug.

FIG. 4 is a front view of the alarm enabled earplug.

FIG. 5 is a back view of the alarm enabled earplug.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Two-Part Constructed Enabled Earplug

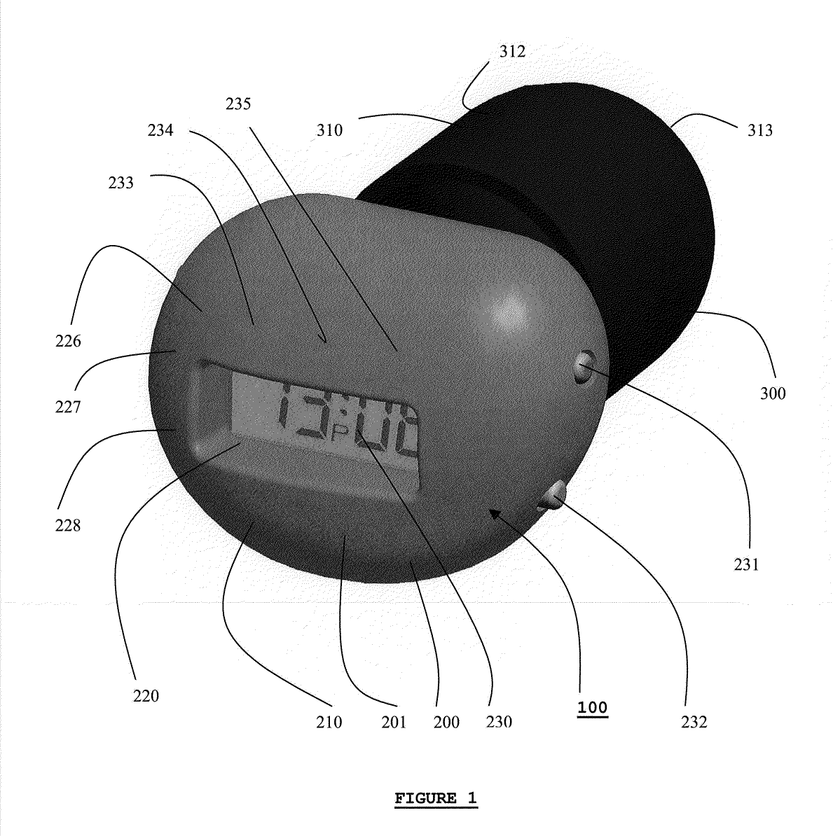

FIG. 1 illustrates, by way of example, one version of an alarm enabled earplug 100. The enabled earplug 100 is preferably of two-part construction having a first section 200 and a corresponding second section 300. The first section 200 includes an exterior casing 210 and an internal cavity 220. The internal cavity has a sufficient size and dimension to house and maintain a digital sound system 230. The digital sound system 230 includes a first programming button 231 and a corresponding second programming button 232. Both buttons (231 and 232) function to provide data and parameters to the digital sound system 230.

The digital sound system 230 further includes a programmable memory 233, a processor 234, and an internal power source 235 (which can be a battery). Optionally, the digital sound system 230 can attach to a display 240, which provides a digital read-out. The memory 233 and processor 234 can include various programs, including a digital clock function, a timer, and a count down feature. The digital sound system can also include a temperature sensor 226 and a pedometer 227 or GPS chip 228 to determine the distance traveled.

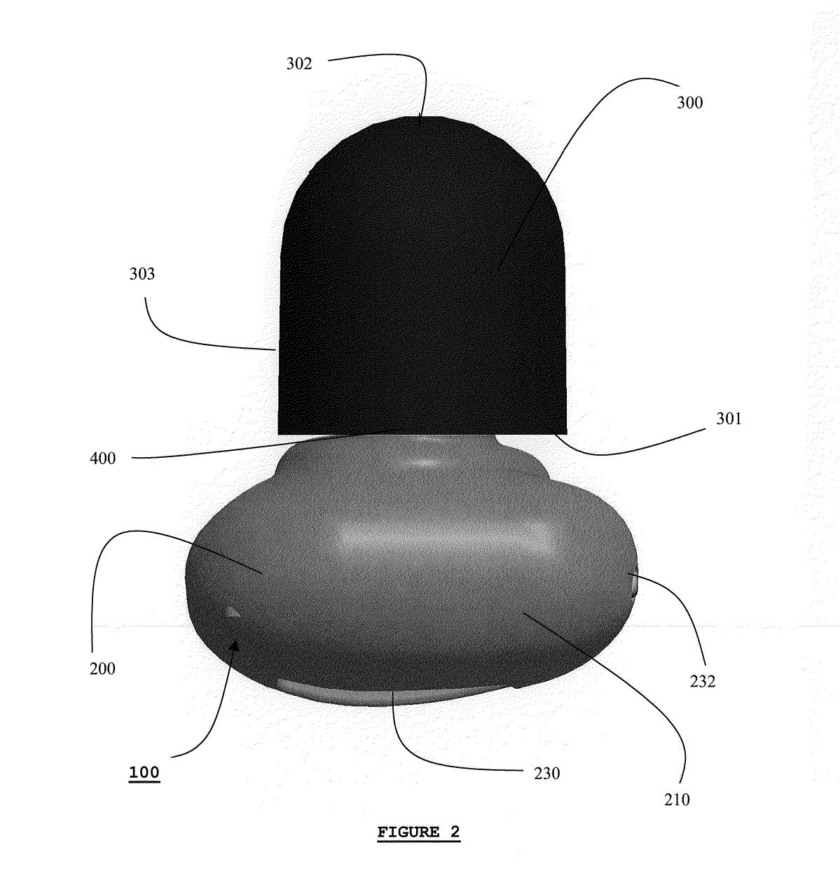

FIG. 2 provides a top view of the two-part construction of the enhanced earplug 100. As shown, the second section 300 of the enhanced earplug 100 includes a deformable member 310. The deformable member 310 may include a flat first end 311, a cylinder 312 and a semi-circular second end 313. This deformable member 310 is preferably made of memory foam 320 capable of being squeezed and then inserted into a user's ear canal. This allows a customized fit of the deformable member 310 within the ear canal to effectuate an essentially sound proof seal.

One or more conduits can optionally be attached to the digital sound system 230 such that they pass through the cylinder 312 of the deformable member 310. These conduits help pass alarms (in the forms of audible sounds such as a beep or other signal) from the digital sound system 230 to the user. Such alarms will be heard and recognized by the use, but not heard or detected outside of the enhanced alarm 100.

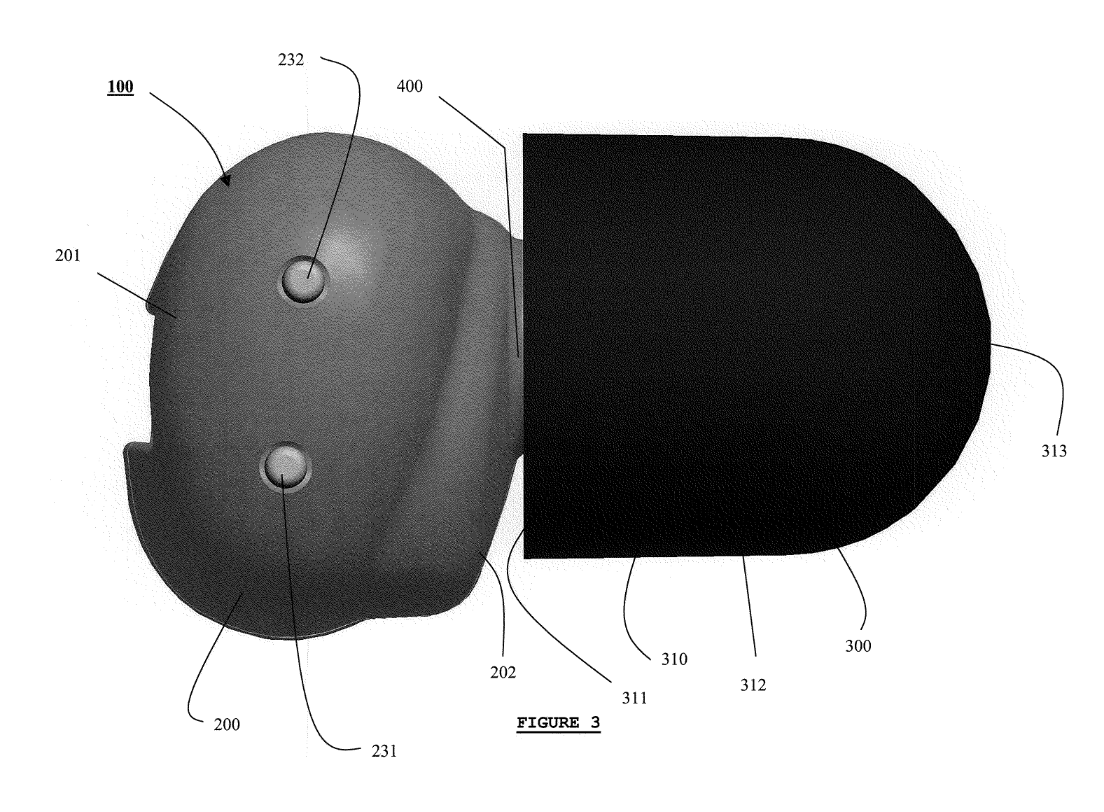

FIG. 3 illustrates how the first second 200 and corresponding second section 300 attach to each other. As shown, the first section 200 is essentially rounded in shape also having a first flat end 201 and a corresponding second flat end 202. The second flat end 200 of the first section 200 attaches to the first flat end 311 of the deformable member 310 (of the second section 300).

As further shown in FIG. 3, an optional pivot member 400 can be placed between the first section 200 and the second section 300 of the enhanced earplug 100. This allows the first section 200 to move and flex outside of the ear canal while second section 300 remains stationary and fitted within that ear. Put another way, the pivot member 400 allows a user to manipulate and operate the first section 200—including operation of both buttons 231 and 232—while wearing the enhanced earplug 100.

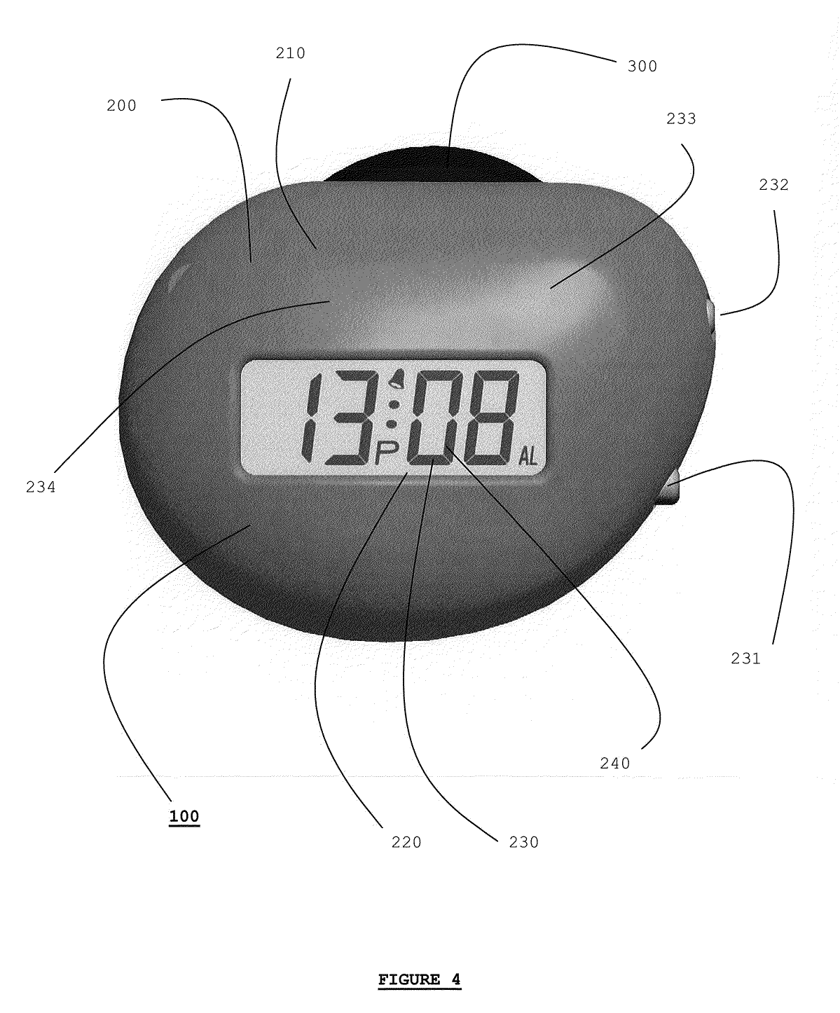

FIG. 4 further illustrates the display 240 of the digital sound system 230 located within the cavity 220. The display 240 allows a user to observe programmed settings for the enhanced earplug 100. For example, a user can verify the correct time setting for the device (i.e., it is 8:15 am). In addition, a user can confirm that an alarm has been set (i.e., an audible noise shall should at 9:00 am). Finally, the display 240 can provide a digital readout of information processed by both the memory device 233 and the processor 234 (i.e., the user traveled 2.4 miles in 31 minutes at an average speed of 4.8 mph).

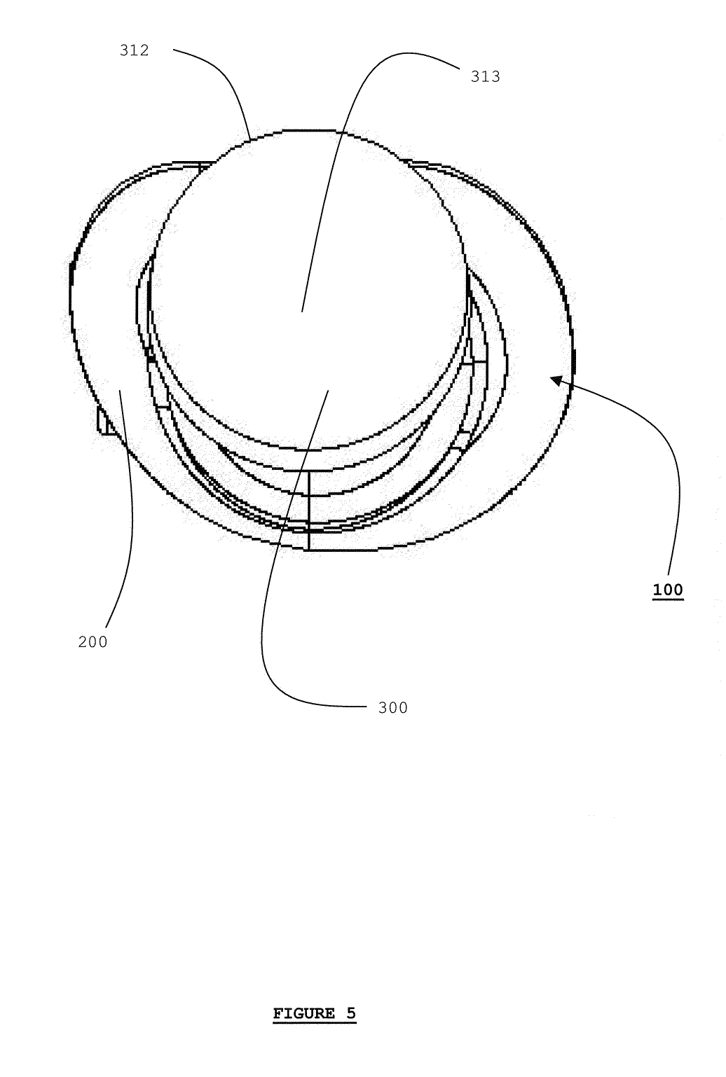

FIG. 5 provides another illustration of the enhanced earplug 100. A shown, the distal end of the second section 300 of the earplug includes a cylinder 312 and a semi-circular second end 313.

### Method of Use

In addition, the invention is directed to a method of using the enhanced earplug 100. The invention first includes the step of turning the digital sound system 230 on. This is done through pressing one or more of the bottoms 231 and 232 located on the first section 200 of the enhanced earplug 100. Next, the method contemplates choosing a particular program stored on the memory device 233 and performed by the processor 234 contained within the digital sound system 230. Such programs can include, but are certainly not limited, to, an audible alarm at a pre-determined time, a countdown, a timer, or a calculation as to distance traveled.

The third step contemplates fitting the deformable member 310 of the second section 300 within the ear canal of a user. This can be done through squeezing the cylinder 313 of the deformable member 310 and then inserting the deformed second section 300 within the ear. Finally, the last step contemplates sending an audible signal from the digital sound system 230 to distal end of the second section 300 through a conduit. This audible signal can be a noise, or digital statement. Alternatively, it could be a vibration.

I claim:

1. An earplug, comprising:
a first portion including an external casing and an internal cavity of sufficient size and dimension to maintain a digital sound system; and
a second portion including a deformable member having a generally cylindrical shape and a semi-circular distal end.

2. The earplug of claim 1, wherein:
the first portion is essentially rounded in shape having a first flat end and a second flat end.

3. The earplug of claim 2, wherein:
the second flat end of the first portion is connected to the first flat end of the deformable member through a pivot member.

4. The earplug of claim 1, wherein:
the digital sound system includes a programmable memory, a processor and an internal power source.

5. The earplug of claim 4, wherein:
the digital sound system further includes a display that provides a digital read out.

6. The earplug of claim 4, wherein:
the digital sound system further includes a first programming button and a corresponding second programming button.

7. The earplug of claim 4, wherein:
the digital sound system further includes a temperature sensor.

8. The enhanced earplug of claim 4, wherein:
the digital sound system further includes a pedometer or GPS chip to determine distance traveled.

9. The enhanced earplug of claim 1, wherein:
there is a conduit positioned within the second portion to help pass alarms from the digital sound system to a user.

10. A method of alerting a user wearing earplugs, the method comprising the steps of:
(a) turning on a digital sound system positioned within a first portion of an enhanced earplug;
(b) choosing a particular program stored on a memory device connected to the digital sound system, the program stored on a memory device and performed by a processor also connected to the digital sound system;
(c) fitting a deformable member located on a second portion of the enhanced earplug within an ear canal of a user, the deformable member having a cylinder and a semi-circular second end; and
(d) sending an audible signal from the digital sound system the user through the semi-circular second end of the deformable member.

11. The method of claim 10, wherein:
a vibration or digital statement is sent, instead of an audible signal, from the digital sound system.

12. The method of claim 10, wherein:
the first portion of the enhanced earplug is essentially rounded in shape having a first flat end and a correspond second flat end.

13. The method of claim 12, wherein:
the second flat end of the first portion is connected to the first flat end of the deformable member through a pivot member.

14. The method of claim 10, wherein:
the digital sound system includes a programmable memory, a processor and an internal power source.

15. The method of claim 10, wherein:
the digital sound system further includes a display that provides a digital read out.

16. The method of claim 10, wherein:
the digital sound system further includes a first programming button and a corresponding second programming button.

17. The method of claim 10, wherein:
the digital sound system further includes a temperature sensor.

18. The method of claim 10, wherein:
the digital sound system further includes a pedometer or GPS chip to determine distance traveled.

19. The method of claim 10, wherein:
there is a conduit positioned within the second portion to help pass alarms from the digital sound system to a user.

20. An enhanced earplug, comprising:
an external casing and an internal cavity of sufficient size and dimension to maintain a digital sound system; and
a deformable member having a first flat end, a cylinder and a semi-circular second end.
